(19) United States
(12) Patent Application Publication
(10) Pub. No.: US 2024/0403713 A1
(43) Pub. Date: Dec. 5, 2024

(54) IMPLEMENTING AND MAINTAINING FEEDBACK LOOPS IN RECOMMENDATION SYSTEMS

(71) Applicant: Netflix, Inc., Los Gatos, CA (US)

(72) Inventors: Ding Tong, Los Gatos, CA (US); Qifeng Qiao, Los Gatos, CA (US); Justin Derrick Basilico, Los Gatos, CA (US); Ting-Po Lee, San Jose, CA (US); James McInerney, San Jose, CA (US)

(21) Appl. No.: 18/679,215

(22) Filed: May 30, 2024

Related U.S. Application Data
(60) Provisional application No. 63/505,157, filed on May 31, 2023.

(51) Int. Cl. G06N 20/00

(52) U.S. Cl. CPC G06N 20/00

(57) ABSTRACT

A computer-implemented method includes identifying offline evaluation metrics that indicate, for a given feedback loop in a recommendation system, various feedback loop characteristics that are detrimental to the feedback loop. The method also includes generating a predictive machine learning (ML) model that correlates the identified offline evaluation metrics with indications of those feedback loop characteristics that are detrimental to the feedback loop. The method further includes instantiating the predictive ML model to predict, using the correlated offline evaluation metrics and the detrimental feedback loop characteristics, how the feedback loop will be negatively affected over time, and providing, to at least one entity, an indication of how the feedback loop will be negatively affected over time due to the detrimental feedback loop characteristics. Various other methods, systems, and computer-readable media are also disclosed.

### CROSS REFERENCE TO RELATED APPLICATION

This application claims priority to and the benefit of U.S. Provisional Application No. 63/505,157, filed May 31, 2023, entitled “Navigating Feedback Loops in Recommender Systems,” the disclosure of which is incorporated, in its entirety, by this reference.

### BACKGROUND

Many entities implement recommendation systems to learn their customers' interests and recommend products and services that are tailored to their customers' interests. Recommendation systems typically learn, through a variety of interactions with different users, what each of those users like. For example, a media streaming service may track users' media selections and use those selections to drive future recommendations. In at least some cases, these recommendation systems may analyze feedback loops to identify or measure skew or bias that has been introduced over time. These feedback loops, however, often fail to adjust over time and can, themselves, become subject to bias.

### SUMMARY

As will be described in greater detail below, the present disclosure generally describes systems and methods for implementing ML models to predict how feedback loops may be negatively affected over time and to potentially take steps to reduce or eliminate those negative effects within the feedback loops.

In one example, a computer-implemented method for implementing ML models to predict how feedback loops will be negatively affected over time is provided. The method includes identifying offline evaluation metrics that indicate, for a given feedback loop in a recommendation system, various feedback loop characteristics that are detrimental to the feedback loop. The method further includes generating a predictive machine learning (ML) model that correlates the identified offline evaluation metrics with indications of the feedback loop characteristics that are detrimental to the feedback loop. The method next includes instantiating the predictive ML model to predict, using the correlated offline evaluation metrics and the detrimental feedback loop characteristics, how the feedback loop will be negatively affected over time and providing, to an entity, an indication of how the feedback loop will be negatively affected over time due to the detrimental feedback loop characteristics.

In some embodiments, the predictive ML model further predicts a degree to which the feedback loop will be negatively affected over time. In some cases, predicting the degree to which the feedback loop will be negatively affected includes predicting the degree to which bias will negatively affect the feedback loop. In some examples, the method further includes generating a plurality of predictive ML models within the recommendation system.

In some cases, the method further includes analyzing the plurality of predictive ML models to determine which predictive ML model has the least amount of bias over a specified period of time. In some embodiments, the method further includes providing recommendation system usage data to the plurality of predictive ML models and performing an A/B test using at least one of the predictive ML models and some of the usage data.

In some cases, the method further includes determining, based on the A/B test, which predictive ML model is most efficient at performing predictions. In some examples, the predictive ML models each measure a different type of negative effect on the feedback loop. In some cases, the predictive ML models each measure a different type of bias in the feedback loop.

In some embodiments, the predictive ML model is implemented to detect, in the recommendation system, when a feedback loop is being implemented. In some cases, the predictive ML model is implemented to predict which metrics would be most effective at identifying bias in the feedback loop. In some examples, each predictive ML model implements different predictive metrics. In some cases, the method further includes debiasing the feedback loop, and implementing various metrics to determine a degree to which the debiasing reduces bias in the feedback loop.

A corresponding system includes at least one physical processor and physical memory comprising computer-executable instructions that, when executed by the physical processor, cause the physical processor to: identify offline evaluation metrics that indicate, for a given feedback loop in a recommendation system, various feedback loop characteristics that are detrimental to the feedback loop, generate a predictive machine learning (ML) model that correlates the identified offline evaluation metrics with indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to an entity, an indication of how the feedback loop will be negatively affected over time due to the detrimental feedback loop characteristics.

In some examples, a corresponding non-transitory computer-readable medium is provided that includes one or more computer-executable instructions that, when executed by at least one processor of a computing device, cause the computing device to: identify offline evaluation metrics that indicate, for a given feedback loop in a recommendation system, feedback loop characteristics that are detrimental to the feedback loop, generate a predictive machine learning (ML) model that correlates the identified offline evaluation metrics with indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to an entity, an indication of how the feedback loop will be negatively affected over time due to the detrimental feedback loop characteristics.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for implementing ML models to predict how feedback loops will be negatively affected over time.

FIG. 3 illustrates an alternative example computer architecture in which the embodiments described herein may operate.

FIG. 4 illustrates an embodiment in which different measurements are generated for different machine learning agents.

FIG. 5 illustrates an embodiment of a chart showing offline replay metrics in simulations.

FIG. 6 illustrates an embodiment of a chart in which measured values for entropy and novelty metrics are shown.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to implementing ML models to predict how feedback loops may be negatively affected over time. In some cases, the methods and systems described herein also take steps to reduce or eliminate those negative effects within the feedback loops.

As noted above, many recommendation systems implement feedback loops. These feedback loops are designed to ensure that recommendation systems continue to recommend items that would be most relevant to users. Feedback loops, however, are prone to biasing and other negative effects. For closed-loop feedback systems that consume only their own data, biasing may be particularly strong. The term “biasing,” as used herein, refers to a feedback loop's tendency to shift toward certain recommendations over time and away from other recommendations. Because closed-loop feedback systems are self-feeding, a small amount of bias may quickly lead to larger amounts of bias. In practical examples, this can lead to recommendation systems repeatedly recommending the same type of content or recommending content that would not appeal to the target user. While open-loop feedback systems implement data from other systems, and are thus less prone to bias or skew, these negative effects can cause similar harm to open-loop systems.

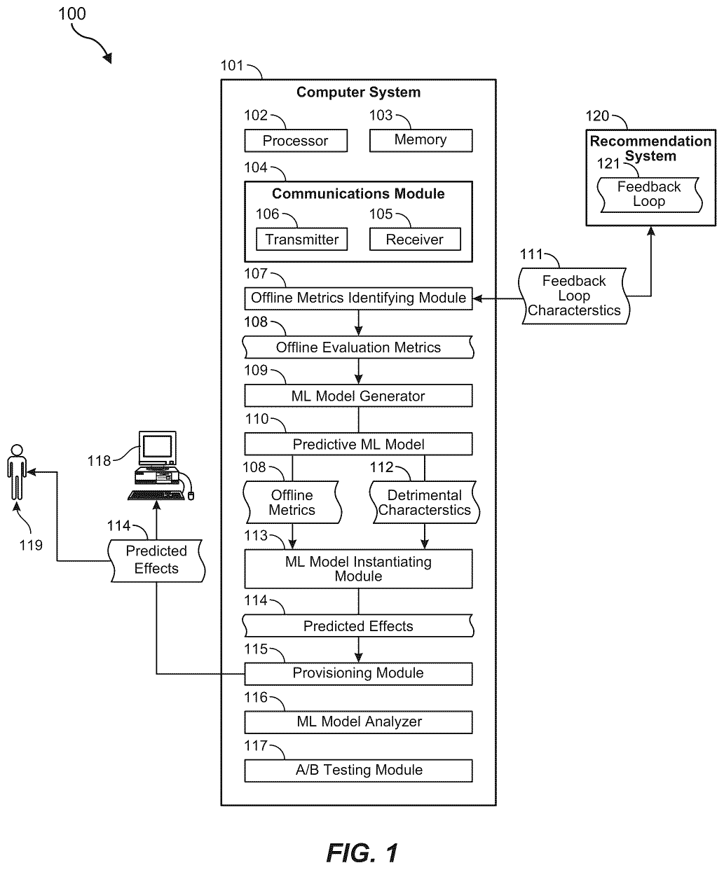

In contrast, the embodiments herein may be implemented to analyze and understand the bias in a system, to measure that bias using specific metrics, and to potentially correct or mitigate the bias in the feedback loop. At least in some cases, the systems described herein are configured to identify offline metrics that indicate, for a given feedback loop in a recommendation system, different feedback loop characteristics that may be detrimental to the feedback loop. The system then generates predictive machine learning (ML) models that correlate the identified offline evaluation metrics with indications of the feedback loop characteristics that are detrimental to the feedback loop. This predictive ML model can then predict, using the correlated offline evaluation metrics and the detrimental feedback loop characteristics, how the feedback loop will be negatively affected over time. This information is then provided to a user or company to indicate how the feedback loop will be negatively affected over time due to the detrimental feedback loop characteristics. The information may also indicate how to mitigate or correct the negative effects in the feedback loop. This process will be described in greater detail below with reference to FIGS. 1-9.

FIG. 1, for example, illustrates a computing environment 100 in which the negative effects of feedback loops are identified, measured, and mitigated. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes an offline metrics identifying module 107. The offline metrics identifying module 107 is configured to identify offline evaluation metrics 108 that indicate, for a feedback loop (e.g., feedback loop 121 of recommendation system 120), various feedback loop characteristics 111 that are detrimental to the feedback loop 121. As the term is used herein, a “feedback loop” refers to a system or method for receiving and analyzing feedback information that is used to perform a specific function in a recommendation system. In the embodiments herein, feedback loops may be used to improve the functioning of a recommendation system 120.

A “recommendation system,” as the term is used herein, may be configured to recommend or offer items to users according to an algorithm indicating which items the user would likely prefer to see or interact with. In at least some cases, the recommendation system 120 may be implemented in conjunction with a media streaming service that provides television shows and movies on demand. In such cases, the recommendation system 120 accesses an ever-changing media catalog and determines, based on past selections from a user and/or based on selections from other users, which media items to present to a given user.

The feedback loop 121 may be used in conjunction with the recommendation system 120. The feedback loop 121 may analyze user selections, user watching behavior, user scrolling behavior, or other information to refine and provide feedback to the recommendation system 120. In this manner, the feedback loop 121 helps the recommendation system 120 continually present media items (or other items, such as advertisements, e-commerce products, services, social network offerings, etc.) that the user will likely be interested in. The feedback loop itself, however, may be prone to skew, bias, or other detrimental effects. For instance, in some cases, the feedback loop 121 may be self-reinforcing, which can lead to unpredictable and/or undesirable outcomes, such as popularity bias, lack of diversity, or amplification of existing biases that lead to degraded performance over time.

The embodiments herein are designed to identify offline metrics that will indicate which detrimental feedback loop characteristics lead to bias or other negative effects. Those metrics can be measured and quantified and, ultimately, used to mitigate the harmful effects. In FIG. 1, for example, an ML model generator 109 can take the offline evaluation metrics 108 and generate or train a predictive ML model 110 to correlate the offline evaluation metrics 108 with the detrimental feedback loop characteristics 112 associated with the feedback loop 121. The ML model instantiating module 113 can then instantiate the trained, predictive ML model 110 to predict how the feedback loop 121 will be negatively affected over time (e.g., identifying negative effects 114), based on the correlated offline evaluation metrics 108 and the detrimental feedback loop characteristics 111. These predicted effects 114 are then sent, by provisioning module 115, to various entities (e.g., user 119, computer system 118, businesses or other organizations, etc.) and are used to mitigate the negative effects that are predicted to occur to the feedback loop 121 over time. This process will be described in greater detail with respect to method 200 of FIG. 2 and FIGS. 1-9 below.

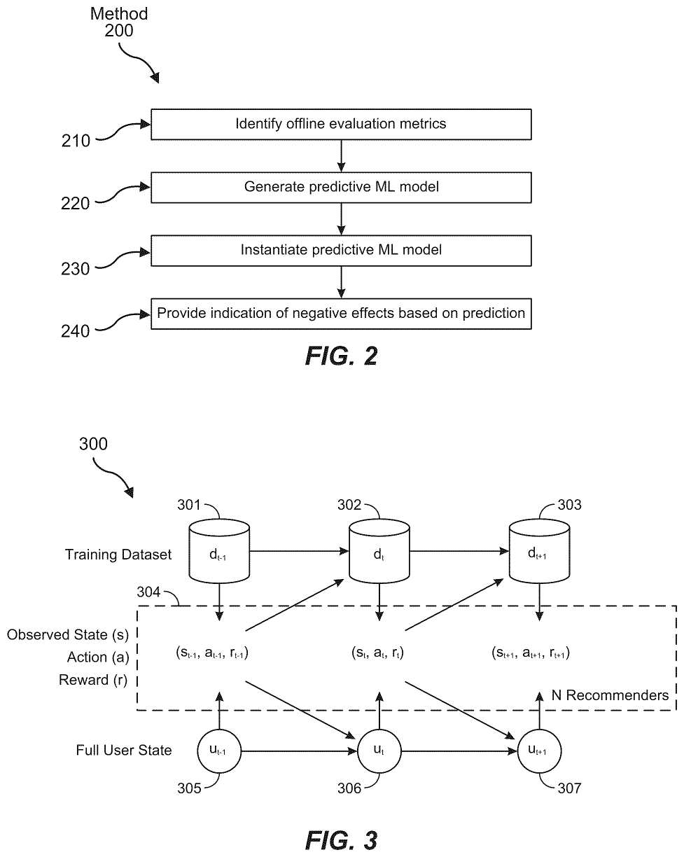

FIG. 2 is a flow diagram of an exemplary computer-implemented method 200 for implementing ML models to predict how feedback loops will be negatively affected over time. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for identifying offline evaluation metrics 108 that indicate, for a given feedback loop 121 in a recommendation system 120, various feedback loop characteristics 111 that are detrimental to the feedback loop. At step 220, method 200 includes generating a predictive ML model 110 that correlates the identified offline evaluation metrics 108 with indications of the feedback loop characteristics 112 that are detrimental to the feedback loop 121. Method 200 next includes, at step 230, instantiating the predictive ML model 110 to predict, using the correlated offline evaluation metrics 108 and the detrimental feedback loop characteristics 112, how the feedback loop will be negatively affected over time. At step 240, the method includes providing, to at least one entity, an indication of how the feedback loop 121 will be negatively affected over time due to the detrimental feedback loop characteristics 112.

As noted above, feedback loops in recommendation systems are processes in which the output of the predictive ML model (e.g., an agent) is used as an input to update or retrain itself. Some feedback loops in recommender systems have the potential to amplify bias, leading to a deterioration of system performance. The embodiments herein may implement different kinds of feedback loops (open or closed) and may be deployed with various types of recommendation systems. These embodiments also describe how feedback loops can be amplified and used to measure the full impact of feedback loops. In at least some embodiments, offline evaluation frameworks are implemented as surrogates for identifying long-term feedback loop bias.

Recommendation systems (e.g., 120 of FIG. 1) are used in many online platforms, facilitating personalized media, e-commerce, social networking, advertising, and information retrieval. When such recommendation systems have outputs that influence their own future inputs, a feedback loop is formed. In certain cases, the feedback loop is self-reinforcing and can lead to unpredictable and/or detrimental outcomes. For instance, the self-reinforcing characteristics of feedback loops can lead to popularity bias, lack of diversity, or amplification of existing biases that potentially lead to degraded performance over time.

One component of feedback loops in recommendation systems is the use of data originating from user interactions with previously recommended content (e.g., media content) to train the recommendation system. In at least some embodiments, the systems herein analyze the importance of the source of data in the cause of harmful effects and in the mitigation of harm in feedback loops. For example, the systems herein may develop patterns of closed-loop and open-loop retraining that arise in recommendation systems. These patterns of retraining may be implemented in situations where multiple nested models determine which recommendations users see on the recommendation platform (e.g., on a media streaming platform).

In at least some cases, the embodiments herein gain insight on feedback patterns through repeated online and offline evaluation. Some recommendation metrics (e.g., 108), such as precision, recall, normalized discounted cumulative gain (NDCG), replay, and take-rate, even when adjusted for policy mismatch using inverse propensity scoring or explore data, ignore the dynamic effects of retraining and may make it difficult to diagnose and analyze feedback loops. To address this, the embodiments herein provide an evaluation framework for recommendation systems to support the analysis of feedback loops in a systematic manner.

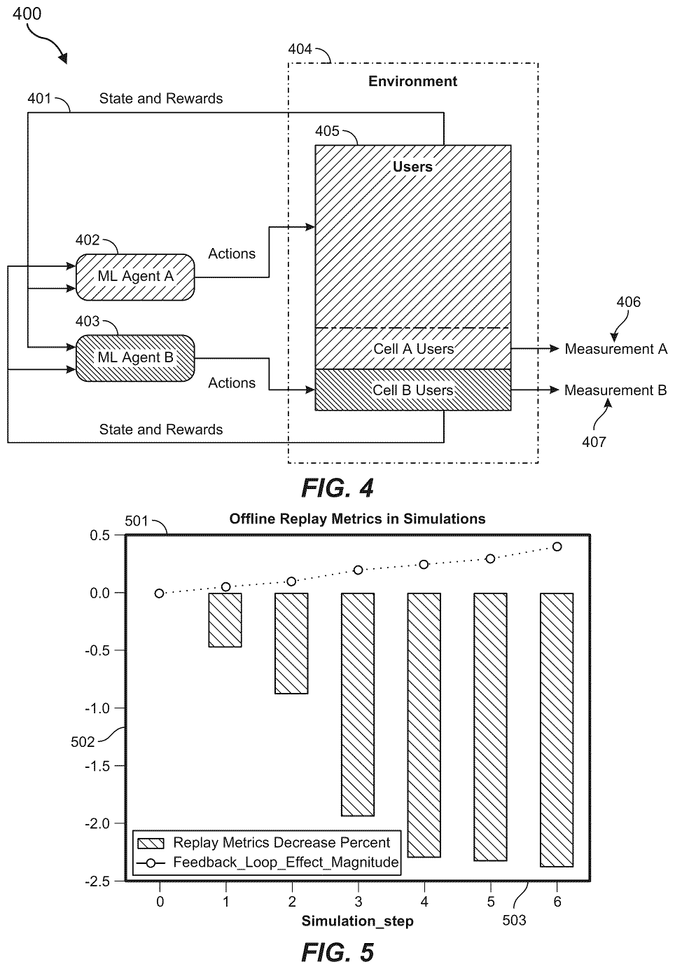

FIG. 3 illustrates an embodiment of a feedback loop 300. In the context of recommendation systems, as depicted in FIG. 3, a feedback loop is an iterative process in which recommendation systems (or “recommenders” herein) interact with users, receive feedback based on their actions, and update their models accordingly. FIGS. 3 and 4 use at least some terminology from policy learning to describe this process, encompassing the environment (e.g., users), agents (e.g., recommenders), actions (e.g., recommendations), and rewards (e.g., feedback, such as clicks, purchases, streams, etc.).

In some embodiments, the feedback loop process may follow these steps: 1) Observation, where the ML agent observes the state of the environment. Observed state(s) is a set of variables that represents the relevant aspects of the environment, such as the recommended products, users' past interaction histories, text, or media information that describes the environment. 2) Reinforcement learning (RL) specifically defines state information and models how the RL system transits into the next state, while other supervised learning algorithms and contextual bandits use feature vectors to represent the observed data (e.g., 301, 302, 303) and assume the feature vectors are fixed without modeling how the feature vectors change over time.

3) Action selection (s->a), where the predictive ML agent selects actions to recommend products (e.g., the personalized homepage of a streaming service) (304). 4) Feedback: users have an experience with the recommended products (captured at 305, 306, and/or 307). The predictive ML agent will collect explicit or implicit feedback in the form of a reward. The reward (r) may be a scalar value that reinforces or discourages certain decisions from the ML agent. 5) Model update: the ML agent will retrain with a new collection of observations and feedback (s, r). 6) Iteration: the above process repeats as the ML agent continues to observe states, take actions, collect feedback and retrain.

The feedback loop 300 can be either closed-loop or open-loop. A closed feedback loop refers to a situation where the agent's actions influence the next state of the environment, and the agent receives feedback on only the effects of its own actions (N=1 in FIG. 3). In contrast, in an open feedback loop, the agent may receive feedback on the effects of actions taken by other agents or factors outside of its control (N>1 in FIG. 3). The less the feedback depends on actions taken by other agents, the closer it is to a closed loop and the stronger the impact of the feedback loop is. In the embodiments herein, the ML agent can learn and adapt to the individual user's preferences over time with its own actions.

In many personalization use cases, the systems herein provide closed-loop predictive ML agents for recommender systems, so that the agents can learn and adapt to the individual user's preferences over time and minimize dependencies on other user's data. However, in some cases, it may be difficult to achieve a fully closed loop, especially when introducing a new ML agent alongside existing agents in a system. The new ML agent often starts in an open-loop stage during its initial steps, as shown in FIG. 3.

In t_0, the systems herein may train the new ML agent π based on the correction of data generated by another agent's policy n′, which puts the agent in an open loop (N>1 in FIG. 3). In t_1, the systems herein collect the reward r_1 and state s_1 of the new agent from the environment, but the agent remains in an open loop (N>1 in FIG. 3) if the agent is trained based on r_1 and s_1. This is because r_1 and s_1 are generated by the agent n which is trained on another agent's policy n′, which can impact r_2 and s_2. In at least some cases, the systems herein train the new ML agent using its own rewards and states (r_1 and s_1), along with other agents' rewards and states ( [symbol] r′ [symbol] _1 and [symbol] s′ [symbol] _1) to increase data volume, which may increase the difficulty in achieving a closed loop.

At least in some cases, the systems herein may consider the new agent to be in closed loop (N=1 in FIG. 3) only until t_n when the agent is trained by rewards r_(n−k), . . . , r_n and states s_(n−k), . . . , s_n from the above steps, and the rewards and states from the above steps are generated by actions taken from the agent trained on the agent's own rewards and actions. Hence, when evaluating a new recommender system, the systems described herein discern whether the feedback loop is in an open-loop or closed-loop stage. Furthermore, when deploying a recommender system aiming to achieve closed-loop functionality, the systems herein may introduce intentional delays to await the closed-loop state before drawing any definitive conclusions from evaluations.

In some cases, measuring the performance of predictive ML agents in online split tests (A/B tests) may be challenging when feedback loops exist. When two predictive ML agents do not have closed feedback loops on their own or are involved in each other's feedback loop, comparison between them in online split tests may be biased. In FIG. 4, a split test setup 400 is presented that measures the difference in performance between two predictive ML agents, where the feedback loops are not completely split. Neither of the feedback loops of ML agents A and B is fully closed and, as a result, the actions taken by one ML agent (e.g., 402) are dependent on another ML agent (e.g., 403). The difference between measurement A 406 and measurement B 407 is no longer an unbiased estimator of the performance difference between two ML agents.

In one embodiment, the measurement bias between two ML agents may be mitigated with feedback loops by randomly splitting the users 405 in environment 404 into two groups and allowing each ML agent (402/403) to be on its own closed loop. In a closed-loop recommender system (e.g., on an internet website), the systems herein may introduce a new ML agent to mitigate the feedback loop bias in the existing ML agent. In such cases, the impact of the feedback loop varies across different stages from the time of its introduction. To overcome the measurement challenges, the systems herein may set up and run online split tests, such that both new and existing ML agents are on their own closed loop. During the initial stages of the new ML agent, the systems herein may detect short-term business metric degradations, as the ML agent may still be in the open-loop stage. However, once the new ML agent becomes closed loop, the business metrics may turn positive. As such, having and continuing, precise measurements online in an ongoing manner until the new ML agent reaches the closed loop stage may be beneficial.

The embodiments described herein thus measure the long-term feedback loop bias in a recommendation system. In some cases, this measurement may take a considerable amount of time. To reduce this amount of time, the systems herein provide a set of offline evaluation metrics (e.g., 108 of FIG. 1) that enable substantially immediate measurement of feedback loop bias by capturing various types of biases that can occur and be amplified in the feedback loop. These offline evaluation metrics serve as surrogates for assessing long-term feedback loop harm. As such, computations that once took multiple days, weeks, or months, can now be performed in hours or less.

During the action selection stage, the systems herein may encounter different biases that can be amplified as part of the feedback loop. Popularity bias occurs when the agent tends to select actions that have been selected more frequently in the past, even if they are not the best actions. In such cases, the systems herein may recommend popular items more than their popularity would warrant, as the feedback loop causes shifts in (media) item consumption. To measure this bias, the systems herein use novelty and entropy metrics, among potentially other metrics. Unfairness bias occurs when the agent is biased toward or against certain states or actions, leading to unfair outcomes. The embodiments herein may additionally or alternatively employ fairness metrics, such as calibration, equality of odds, and others, depending on the specific focus of the recommender.

New item bias occurs when the agent tends to avoid selecting actions that it has not selected before, leading to a limited exploration of the environment. To assess this bias, the systems herein may implement certain metrics on a cold start. During the feedback collection stage, additional biases can arise and be amplified. Exposure bias occurs when the agent's learning is based on a limited set of actions and experiences, leading to an overgeneralization of the true values. The systems herein evaluate this bias using metrics like diversity and the number of explored actions.

Selection bias occurs when the reward (e.g., 401) is partially observed, leading to an incomplete or biased representation of the environment. For example, users may only interact with items they like, or interact more with top positions (also known as position bias). This bias can be assessed using importance sampling-based methods (IPS). Using a collection of one or more offline evaluation metrics 108, the systems herein are able to select surrogates for the long-term feedback loop harm by constructing predictive models that correlate these metrics with the actual long-term feedback loop impact of the targeted recommender system. At least in some embodiments, these metrics can be used to measure feedback loop bias and prevent long-term harm.

To understand the long-term feedback loop bias, the systems herein provide a method that directly simulates the feedback loop effect on the distribution of training data. At the beginning step t_0 of the simulations, the systems herein, at least in some cases, use real-world production data and models (although simulation data or models could also be used). These systems simulate the training data at time t_1 using the output of the model at time t_0, retrain the model, and continue the simulations to time t_2. The solid bars along the x-axis 503 in chart 501 of FIG. 5 represent the performance of the predictive ML model that fails to address the feedback loop effect, showcasing a decline in performance over time throughout the simulation. The line with dots starting at 0 on the y-axis 502 represents how much feedback loop bias is consistently magnified at each simulation step. Repeating this simulation process with different proportions of the closed loop data, the systems herein can collect different data points of feedback loop bias and build predictive models to select surrogates from the offline evaluation metrics.

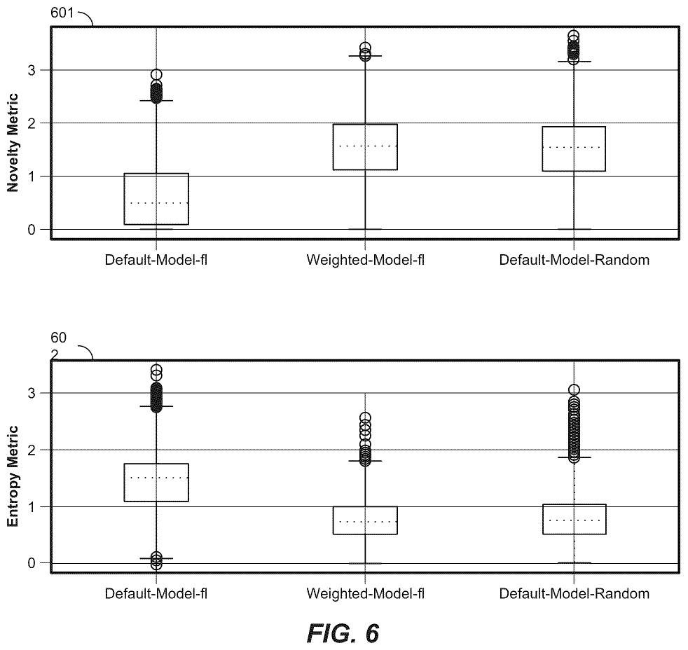

In one personalization embodiment, the systems described herein have identified novelty and entropy of impressions to be two of the effective surrogates of long-term feedback loop harm. In some cases, the personalization system may be instantiated in an environment without any feedback for the model training, and then feedback may be slowly added over time. In FIG. 6, for example, the systems herein have compared two models on data with a strong feedback loop effect: 1) a default model (labeled as “default-model-FL”) that fails to address feedback loop effect, and 2) a model with importance weights to overcome feedback-loop bias (labeled as “weighted-model-FL”). Another embodiment trains the default model with random uniform exploration data that has no feedback loop effect (labeled as “default-model-random”). A model's robustness in handling training data with different biases is directly correlated with a higher novelty score 601 or a lower entropy score 602. FIG. 6 indicates that the weighted-model-FL performs nearly the same as the default-random model that works in an environment without any feedback loop effect.

As noted above in relation to FIGS. 1 and 2, the systems described herein may be configured to predict various negative effects 114 that will be detrimental to a feedback loop. These negative effects may include any of the different types of bias described herein or other deleterious effects that would cause a feedback loop to perform less than optimally. In some cases, the predictive ML model 110 generated by computer system 101 may be configured to predict the degree to which the feedback loop 121 will be negatively affected over time. Some forms of bias may have less of a negative effect, while other forms of bias may have a more immediate and/or stronger effect. This degree of adverse effect may be used when attempting to mitigate the bias.

For instance, in some cases, if a high degree of adverse effect is predicted by the predictive ML model 110, the mitigation efforts may be instantiated sooner and to a greater degree. The opposite is also the case, where lower degrees of predicted adverse effects may be safely ignored or mitigation efforts may be postponed for a certain amount of time, according to the degree to which the feedback loop 121 will be negatively affected over time. At least in some cases, predicting the degree to which the feedback loop 121 will be negatively affected includes predicting the degree to which bias (or a particular form of bias) will negatively affect the feedback loop. Thus, at least in some embodiments, the predictive ML model 110 may predict, for each of the different types of bias, how that specific type of bias will affect the feedback loop 121.

In some cases, different predictive ML models may be used to analyze and predict the various types of bias. In some embodiments, the ML model generator 109 may generate multiple different predictive ML models within the recommendation system 120. Each of those predictive ML models may be used to identify and measure a different type of bias. Each model may have different operating characteristics and, as such, may be prone to different types of bias. As such, the systems herein (particularly, ML model analyzer 116) may be configured to analyze the various different predictive ML models to determine which predictive ML model has the least amount of bias (or the least amount of a specific type of bias) over a given period of time.

In some embodiments, the recommendation system 120 may keep track of usage data, including retaining information indicating which options were offered to a user and which options the user selected or passed on. In some cases, the recommendation system usage data is provided to the different predictive ML models (e.g., 110). The A/B testing module 117 may then perform at least one A/B test using the various predictive ML models and at least some of the usage data. The A/B tests may be configured to determine which predictive ML model is most efficient at performing predictions. Specifically, the A/B tests may determine which ML model is most efficient at predicting detrimental effects 114 that will lead to different kinds of bias or other negative effects. In some cases, each predictive ML model is configured to measure a different type of negative effect on the feedback loop (e.g., skew or bias). In such cases, each model may be configured to measure a different type of bias in the feedback loop. For instance, one model may be configured to measure popularity bias, another model may be configured to measure a lack of diversity, etc. In this manner, models may be specifically designed and trained to analyze and measure certain types of bias, skew, or other negative effects. Additionally or alternatively, predictive ML models may be configured to measure multiple types of bias. Thus, a single predictive ML model may be configured to measure popularity bias, lack of diversity, and/or other types of bias.

In some cases, predictive ML models (e.g., 110) may be implemented to detect, in the recommendation system 120, when a feedback loop is being implemented. For example, predictive ML model 110 may be implemented to analyze the behaviors and output data of recommendation system 120 and determine that at least one feedback loop 121 is being implemented. The predictive ML model 110 may also determine various feedback loop characteristics 111 of the feedback loop 121. In some examples, the predictive ML model 110 may be implemented to predict which metrics (e.g., 108) would be most effective at identifying bias in the feedback loop. In such cases, each predictive ML model may implement different predictive metrics to determine which types of bias will be (or are most likely to be) exhibited by the feedback loop 121.

Some measures may be taken to debias the feedback loop 121. For example, in cases where one or more types of bias or other negative effects are identified, the systems herein may take steps to debias the feedback loop 121. Various techniques may be implemented to mitigate any identified feedback loop bias such as system exploration and deliberate diversification, in which the systems herein randomly split users into two groups and allow each ML agent to be on its own closed loop. After the mitigation steps have been put into place and are running within the system, the embodiments herein may implement various measurement metrics to determine a degree to which the debiasing has actually reduced bias in the feedback loop 121. The systems herein may be configured to measure the degree of debiasing separately for each type of bias that has been identified within the system. In this manner, the embodiments herein may not only predict which types of bias or other negative effects are likely to occur within a feedback loop, but may also provide corrective measures to reduce bias for feedback loops in a given recommendation system.

In addition to the method described above, a corresponding system is also provided. The system includes at least one physical processor and physical memory comprising computer-executable instructions that, when executed by the physical processor, cause the physical processor to: identify one or more offline evaluation metrics that indicate, for a given feedback loop in a recommendation system, one or more feedback loop characteristics that are detrimental to the feedback loop, generate a predictive machine learning (ML) model that correlates the identified offline evaluation metrics with one or more indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to at least one entity, an indication of how the feedback loop will be negatively affected over time due to the detrimental feedback loop characteristics.

Furthermore, a corresponding non-transitory computer-readable medium is provided that includes one or more computer-executable instructions that, when executed by at least one processor of a computing device, cause the computing device to: identify one or more offline evaluation metrics that indicate, for a given feedback loop in a recommendation system, one or more feedback loop characteristics that are detrimental to the feedback loop, generate a predictive machine learning (ML) model that correlates the identified offline evaluation metrics with one or more indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to at least one entity, an indication of how the feedback loop will be negatively affected over time due to the detrimental feedback loop characteristics.

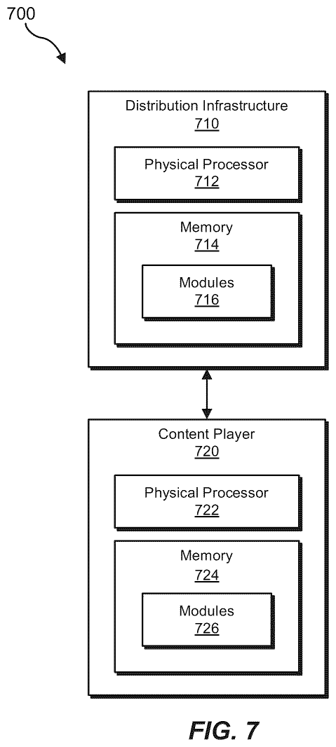

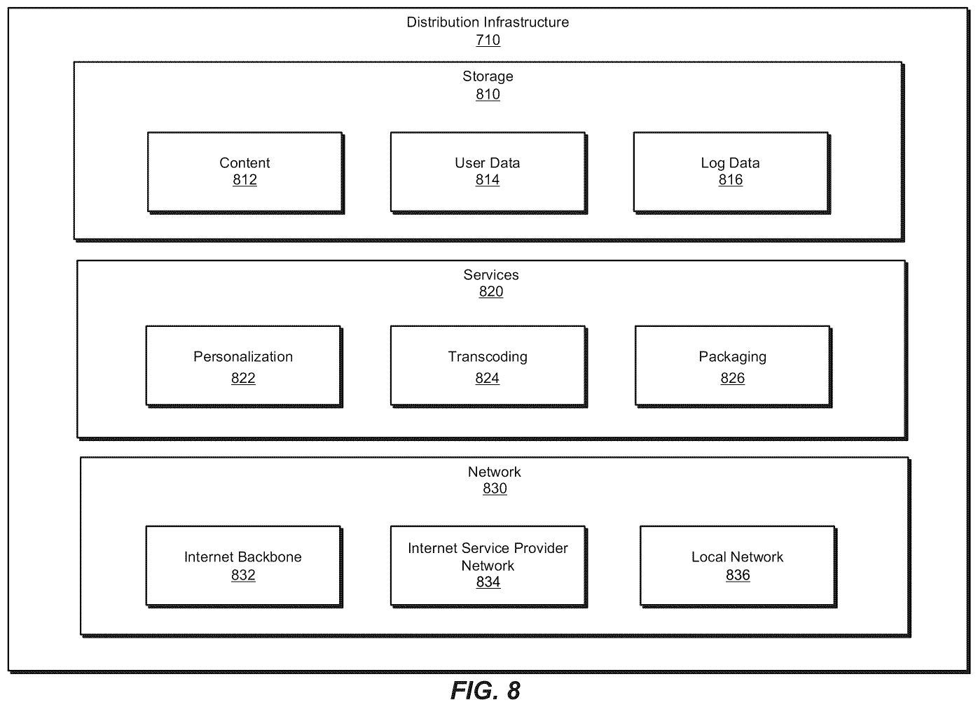

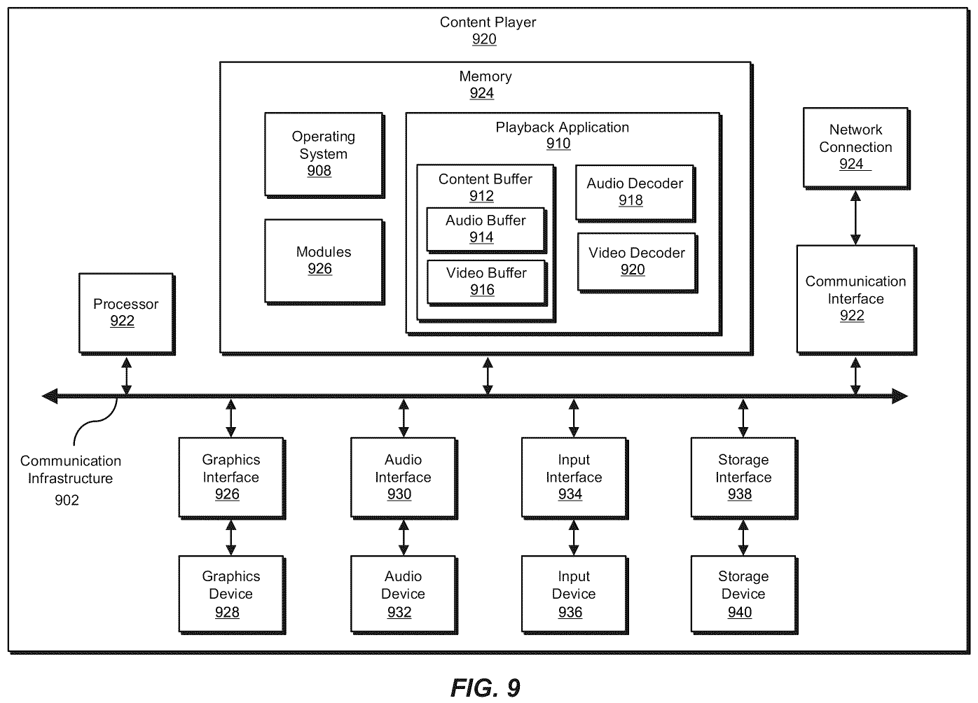

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-9.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and at least one memory device 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Encoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926. Graphics interface 926 is configured to transmit a rendered video signal to graphics device 928. In normal operation, playback application 910 receives a request from a user to play a specific title or specific content. Playback application 910 then identifies one or more encoded video and audio streams associated with the requested title. After playback application 910 has located the encoded streams associated with the requested title, playback application 910 downloads sequence header indices associated with each encoded stream associated with the requested title from distribution infrastructure 710. A sequence header index associated with encoded content includes information related to the encoded sequence of data included in the encoded content.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### Example Embodiments

Example 1: A computer-implemented method comprising: identifying one or more offline evaluation metrics that indicate, for a given feedback loop in a recommendation system, one or more feedback loop characteristics that are detrimental to the feedback loop, generating a predictive machine learning (ML) model that correlates the identified offline evaluation metrics with one or more indications of the feedback loop characteristics that are detrimental to the feedback loop, instantiating the predictive ML model to predict, using the correlated offline evaluation metrics and the detrimental feedback loop characteristics, how the feedback loop will be negatively affected over time, and providing, to at least one entity, an indication of how the feedback loop will be negatively affected over time due to the detrimental feedback loop characteristics.

Example 2. The computer-implemented method of Example 1, wherein the predictive ML model further predicts a degree to which the feedback loop will be negatively affected over time.

Example 3. The computer-implemented method of Example 1 or Example 2, wherein predicting the degree to which the feedback loop will be negatively affected includes predicting the degree to which bias will negatively affect the feedback loop.

Example 4. The computer-implemented method of any of Examples 1-3, further comprising generating a plurality of predictive ML models within the recommendation system.

Example 5. The computer-implemented method of any of Examples 1-4, further comprising analyzing the plurality of predictive ML models to determine which predictive ML model has the least amount of bias over a specified period of time.

Example 6. The computer-implemented method of any of Examples 1-5, further comprising providing recommendation system usage data to the plurality of predictive ML models and performing at least one A/B test using at least one of the plurality of predictive ML models and at least a portion of the usage data.

Example 7. The computer-implemented method of any of Examples 1-6, further comprising determining, based on the at least one A/B test, which predictive ML model is most efficient at performing predictions.

Example 8. The computer-implemented method of any of Examples 1-7, wherein the plurality of predictive ML models each measures a different type of negative effect on the feedback loop.

Example 9. The computer-implemented method of any of Examples 1-8, wherein the plurality of predictive ML models each measures a different type of bias in the feedback loop.

Example 10. The computer-implemented method of any of Examples 1-9, wherein the predictive ML model is implemented to detect, in the recommendation system, when a feedback loop is being implemented.

Example 11. The computer-implemented method of any of Examples 1-10, wherein the predictive ML model is implemented to predict which metrics would be most effective at identifying bias in the feedback loop.

Example 12. The computer-implemented method of any of Examples 1-11, wherein each predictive ML model implements different predictive metrics.

Example 13. The computer implemented method of any of claims 1-12, further comprising debiasing the feedback loop, and implementing one or more metrics to determine a degree to which the debiasing reduced bias in the feedback loop.

Example 14. A system comprising at least one physical processor and physical memory comprising computer-executable instructions that, when executed by the physical processor, cause the physical processor to: identify one or more offline evaluation metrics that indicate, for a given feedback loop in a recommendation system, one or more feedback loop characteristics that are detrimental to the feedback loop, generate a predictive machine learning (ML) model that correlates the identified offline evaluation metrics with one or more indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to at least one entity, an indication of how the feedback loop will be negatively affected over time due to the detrimental feedback loop characteristics.

Example 15. The system of Example 14, wherein the predictive ML model further predicts a degree to which the feedback loop will be negatively affected over time.

Example 16. The system of Example 14 or Example 15, wherein predicting the degree to which the feedback loop will be negatively affected includes predicting the degree to which bias will negatively affect the feedback loop.

Example 17. The system of any of Examples 14-16, wherein the physical processor further generates a plurality of predictive ML models within the recommendation system.

Example 18. The system of Examples 14-17, wherein the physical processor further analyzes the plurality of predictive ML models to determine which predictive ML model has the least amount of bias over a specified period of time.

Example 19. The system of any of Examples 14-18, further comprising providing recommendation system usage data to the plurality of predictive ML models and performs at least one A/B test using at least one of the plurality of predictive ML models and at least a portion of the usage data.

Example 20. A non-transitory computer-readable medium comprising one or more computer-executable instructions that, when executed by at least one processor of a computing device, cause the computing device to: identify one or more offline evaluation metrics that indicate, for a given feedback loop in a recommendation system, one or more feedback loop characteristics that are detrimental to the feedback loop, generate a predictive machine learning (ML) model that correlates the identified offline evaluation metrics with one or more indications of the feedback loop characteristics that are detrimental to the feedback loop, instantiate the predictive ML model to predict, using the correlated offline evaluation metrics and the detrimental feedback loop characteristics, how the feedback loop will be negatively affected over time, and provide, to at least one entity, an indication of how the feedback loop will be negatively affected over time due to the detrimental feedback loop characteristics.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying one or more offline evaluation metrics that indicate, for a given feedback loop in a recommendation system, one or more feedback loop characteristics that are detrimental to the feedback loop;
generating a predictive machine learning (ML) model that correlates the identified offline evaluation metrics with one or more indications of the feedback loop characteristics that are detrimental to the feedback loop;
instantiating the predictive ML model to predict, using the correlated offline evaluation metrics and the detrimental feedback loop characteristics, how the feedback loop will be negatively affected over time; and
providing, to at least one entity, an indication of how the feedback loop will be negatively affected over time due to the detrimental feedback loop characteristics.

2. The computer-implemented method of claim 1, wherein the predictive ML model further predicts a degree to which the feedback loop will be negatively affected over time.

3. The computer-implemented method of claim 2, wherein predicting the degree to which the feedback loop will be negatively affected includes predicting the degree to which bias will negatively affect the feedback loop.

4. The computer-implemented method of claim 1, further comprising generating a plurality of predictive ML models within the recommendation system.

5. The computer-implemented method of claim 4, further comprising analyzing the plurality of predictive ML models to determine which predictive ML model has the least amount of bias over a specified period of time.

6. The computer-implemented method of claim 4, further comprising:
providing recommendation system usage data to the plurality of predictive ML models; and
performing at least one A/B test using at least one of the plurality of predictive ML models and at least a portion of the usage data.

7. The computer-implemented method of claim 6, further comprising determining, based on the at least one A/B test, which predictive ML model is most efficient at performing predictions.

8. The computer-implemented method of claim 4, wherein the plurality of predictive ML models each measures a different type of negative effect on the feedback loop.

9. The computer-implemented method of claim 8, wherein the plurality of predictive ML models each measures a different type of bias in the feedback loop.

10. The computer-implemented method of claim 1, wherein the predictive ML model is implemented to detect, in the recommendation system, when a feedback loop is being implemented.

11. The computer-implemented method of claim 1, wherein the predictive ML model is implemented to predict which metrics would be most effective at identifying bias in the feedback loop.

12. The computer-implemented method of claim 11, wherein each predictive ML model implements different predictive metrics.

13. The computer-implemented method of claim 1, further comprising:
debiasing the feedback loop; and
implementing one or more metrics to determine a degree to which the debiasing reduced bias in the feedback loop.

14. A system comprising:
at least one physical processor;
an electronic display; and
physical memory comprising computer-executable instructions that, when executed by the physical processor, cause the physical processor to:
identify one or more offline evaluation metrics that indicate, for a given feedback loop in a recommendation system, one or more feedback loop characteristics that are detrimental to the feedback loop;
generate a predictive machine learning (ML) model that correlates the identified offline evaluation metrics with one or more indications of the feedback loop characteristics that are detrimental to the feedback loop;
instantiate the predictive ML model to predict, using the correlated offline evaluation metrics and the detrimental feedback loop characteristics, how the feedback loop will be negatively affected over time; and
provide, to at least one entity, an indication of how the feedback loop will be negatively affected over time due to the detrimental feedback loop characteristics.

15. The system of claim 14, wherein the predictive ML model further predicts a degree to which the feedback loop will be negatively affected over time.

16. The system of claim 15, wherein predicting the degree to which the feedback loop will be negatively affected includes predicting the degree to which bias will negatively affect the feedback loop.

17. The system of claim 14, wherein the physical processor further generates a plurality of predictive ML models within the recommendation system.

18. The system of claim 17, wherein the physical processor further analyzes the plurality of predictive ML models to determine which predictive ML model has the least amount of bias over a specified period of time.

19. The system of claim 17, wherein the physical processor further:
provides recommendation system usage data to the plurality of predictive ML models; and
performs at least one A/B test using at least one of the plurality of predictive ML models and at least a portion of the usage data.

20. A non-transitory computer-readable medium comprising one or more computer-executable instructions that, when executed by at least one processor of a computing device, cause the computing device to:
identify one or more offline evaluation metrics that indicate, for a given feedback loop in a recommendation system, one or more feedback loop characteristics that are detrimental to the feedback loop;
generate a predictive machine learning (ML) model that correlates the identified offline evaluation metrics with one or more indications of the feedback loop characteristics that are detrimental to the feedback loop;
instantiate the predictive ML model to predict, using the correlated offline evaluation metrics and the detrimental feedback loop characteristics, how the feedback loop will be negatively affected over time; and
provide, to at least one entity, an indication of how the feedback loop will be negatively affected over time due to the detrimental feedback loop characteristics.
